(19) United States
(12) Patent Application Publication
(10) Pub. No.: US 2015/0178844 A1
(43) Pub. Date: Jun. 25, 2015

(54) Customized Retirement Planning

(71) Applicant: Bank of America Corporation, Charlotte, NC (US)

(72) Inventors: Colby J. Ross, Malden, MA (US); William J. Hunter, Medfield, MA (US); Jeffrey K. Cimini, Needham, MA (US); David C. Tyrie, Winchester, MA (US); Evelyn Varner, Hopkinton, MA (US)

(73) Assignee: Bank of America Corporation, Charlotte, NC (US)

(21) Appl. No.: 14/135,838

(22) Filed: Dec. 20, 2013

(51) Int. Cl. G06Q 40/06

(52) U.S. Cl. CPC G06Q 40/06

(57) ABSTRACT

According to a particular embodiment, a method for customized retirement planning includes displaying a landing page that is a topic dashboard on a mobile device. The topic dashboard depicts a plurality of topic identifiers. Each of the plurality of topic identifiers include an element of a retirement plan. A first user input that identifies a selected topic identifier within the plurality of topic identifiers is received. Topic information pages relating to the selected topic identifier are selected. The topic information pages includes information relating to the element of the retirement plan that corresponds with the selected topic identifier. At least one of the topic information pages is displayed to a user of the mobile device.

### TECHNICAL FIELD OF THE INVENTION

The present invention relates generally to financial planning services, and more specifically to a mobile application for providing customized retirement planning services.

### BACKGROUND OF THE INVENTION

To adequately address the financial needs of an existing or prospective client, a financial advisor must diligently gather information from and disseminate information to the client. For this purpose, financial advisors may use various physical files, written displays and electronic systems. For example, a written questionnaire may be used to gather information so that client objectives, characteristics, preferences, priorities, and goals may be determined. Likewise, written brochures may be used to present one or more financial plans to the client. However, it may be difficult during an initial meeting to provide customized information that take into the account the specific needs and characteristics of the client. Rather, a financial advisor may be required to independently process the gathered information for developing customized information and recommendations at a later time.

### SUMMARY OF THE INVENTION

In accordance with the present disclosure, a mobile electronic application is provided which substantially eliminates or reduces disadvantages and problems associated with previous systems and methods.

According to a particular embodiment, a method for customized retirement planning includes displaying a landing page that is a topic dashboard on a mobile device. The topic dashboard depicts a plurality of topic identifiers. Each of the plurality of topic identifiers include an element of a retirement plan. A first user input that identifies a selected topic identifier within the plurality of topic identifiers is received. Topic information pages relating to the selected topic identifier are selected. The topic information pages includes information relating to the element of the retirement plan that corresponds with the selected topic identifier. At least one of the topic information pages is displayed to a user of the mobile device.

Particular embodiments provide various technical advantages. These techniques provide improved sharing of information between financial advisor professionals and their existing and/or prospective clients, in addition, techniques of the present disclosure provide a holistic approach toward financial and retirement planning that introduce customized and selectable materials related to a set of topics and/or elements of a retirement plan.

Particular embodiments may provide an interactive tool that may be used to educate clients on the various aspects of retirement, discuss personal goals, priorities, and concerns, and discover insights the client may have not had before. For example, the interactive tool may include an interface that provides one or more information pages that present infographic content to a client, solicit demographic or financial information from a client, and/or provide interactive content that may be customized to take into account a client's financial goals and/or situation. For example, the tool may use a framework that explores the client's objectives with respect to each one of a set of elements of a financial or retirement plan. As just one example, the elements of a framework for developing a retirement plan may include one or more of health, family, finances, leisure, giving, home, and work.

In particular embodiments, the interactive tool may be incorporated into a mobile device such as a cell phone or tablet computer for providing financial planning services at a site that is convenient for the client. For example, a financial planner may use the tool during a retirement planning session at a client's house or place of business. The tool may provide the financial planner with access to data and information that the financial planner would not have physical access to at the client's site.

Particular embodiments may provide the ability to develop and offer a comprehensive retirement plan that accounts for all aspects of a client's life. Thus, in addition to determining the customer's needs, the interactive tool may include a plan packager that automatically selects components of a retirement plan based on the information provided by the client during the planning session. Certain embodiments may provide alternative plans that may be displayed to the user on the mobile device for consideration by the user. Additionally, certain embodiments may provide a mechanism for selecting a plan fix enrollment by the customer.

Particular embodiments may provide the ability to provide follow-up resources. For example, the interactive tool may provide a post-meeting package that includes a wide-range of content, articles, videos, a summary of the meeting, and any additional follow-up items requested. For example, in certain embodiments, the interactive tool may include one or more buttons or commands that may be used to email displayed materials directly to the customer's email address.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

FIG. 1 is a block diagram illustrating a system for providing customized retirement planning information to a user of a mobile device;

FIG. 2 is a block diagram illustrating an example financial services system for providing customized retirement planning information;

FIG. 3 is a block diagram illustrating an example embodiment of a mobile device for executing a financial planning application for displaying customized retirement planning information;

FIG. 4 illustrates an example system hierarchy of a graphical user interface on a mobile device;

FIGS. 5A-5H illustrate example interfaces presented on a mobile device for providing customized retirement planning information to a customer;

FIG. 6 illustrates an example process flow for generating and displaying customized financial planning information; and

FIG. 7 illustrates an example process flow for generating and displaying interactive financial planning information.

### DETAILED DESCRIPTION OF THE DRAWINGS

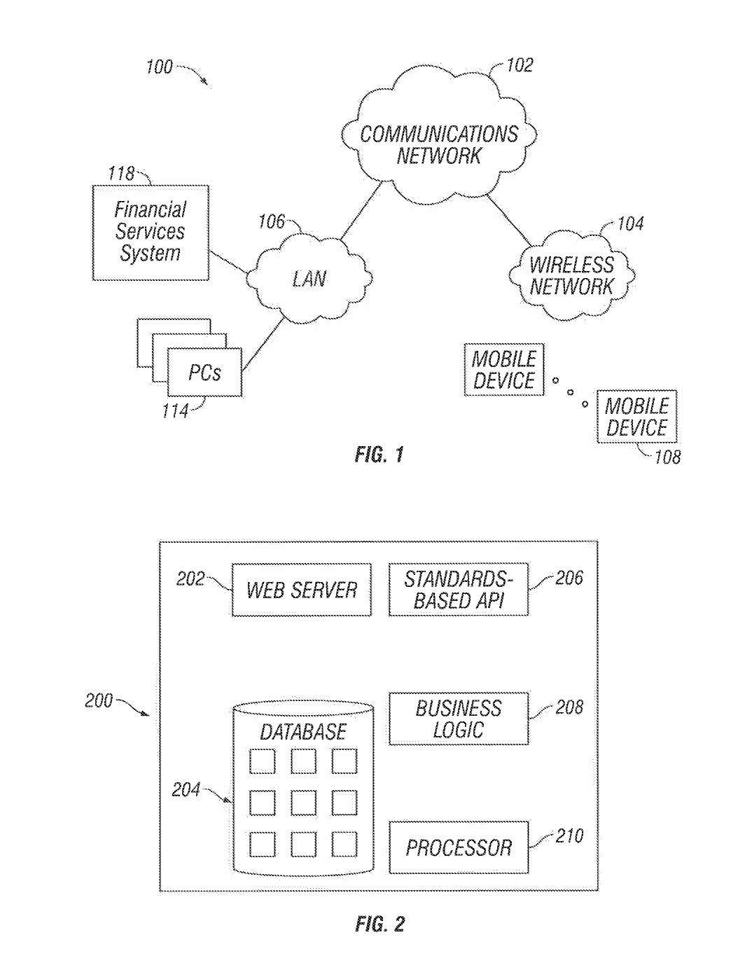

FIG. 1 is a block diagram illustrating a system 100 for providing customized retirement plan information to a user of a mobile device. The elements of system 100 can support a number of different operations, including facilitating the determination of customer priorities with respect to one or more elements within a retirement or financial planning framework. The system 100 may also facilitate the selection and display of customized information relating to information topics determined to be of priority to the customer. For example, the system may be used to prioritize elements such as health, family, leisure, finances, giving, home, work, or other suitable topics based on user-provided information. In certain embodiments, the information displayed to the user may include interactive content that may be selectively adjusted by the customer in response to input received from the customer while viewing the information.

In certain embodiments, system 100 may be used in the development of customized retirement plans that are holistically developed during a planning session conducted at a remote site that is convenient to the customer. Users of system 100 may include financial planners, retirement service providers, or other financial service providers. Under appropriate circumstances, users of system 100 may include customers seeking retirement planning advice while shopping for a retirement plan. Thus, in particular embodiments, system 100 may provide an application that may be downloaded to a mobile device such as a tablet computer, mobile phone, or other network-accessible device associated with the user.

In the illustrated embodiment, system 100 includes a number of elements interconnected by various networks, including a communications network 102, a wireless network 104, and a local area network 106. Networks 102, 104, and 106, represent communications equipment, including hardware and any appropriate controlling logic, for interconnecting elements and facilitating communication between these elements. Communications network 102 may include local area networks (LANs), metropolitan area networks (MANS), wide area networks (WANs), any other public or private network, local, regional, or global communication network, enterprise intranet, other suitable wireline or wireless communication link, or any combination thereof. Communications network 102 may include any combination of gateways, routers, hubs, switches, access points, base stations, and any other hardware, software, or a combination of the preceding that may implement any suitable protocol. For illustrative purposes, system 100 is also shown as including other specific types of networks, including wireless network 104 and local area network 106. The use of these or similar networks facilitate communication between components of system 100 regardless of their geographic location or communication protocols.

As illustrated, system 100 includes a wireless network 104 coupled to communications network 102. Wireless network 104 represents communications equipment, including hardware and any appropriate controlling logic, for interconnecting elements and facilitating communications by wireless devices. In particular embodiments, wireless network 104 may include wireless telephony network that includes gateways, call managers, routers, hubs, switches, access points, base stations, cellular towers, radio networks, satellite telephone equipment implementing appropriate protocols for wireless telephony communications. In certain embodiments, wireless network 104 may operate according to one or more of the 802.11 standards promulgated by the Institute of Electrical and Electronic Engineers (IEEE). Wireless network 104 may include any combination of gateways, routers, hubs, switches, access points, base stations, wireless telephone systems and any other hardware, software, or combination thereof. While only one wireless telephony network 104 has been illustrated, it should be understood that various embodiments may operate using more than one wireless telephony network.

The illustrated embodiment of system 100 also includes a local area network 106 coupled to communications network 102. Local area network 106 represents communications equipment, including hardware and any appropriate controlling logic, for interconnecting elements within a limited network area (as compared with, for example, wide area networks). Local area network 106 may include any combination of gateways, routers, hubs, switches, access points, base stations, and any other hardware, software or combination thereof using suitable protocols to support communications. For example, local area network 106 may be the established network infrastructure deployed by a financial services provider. While only one local area network 106 has been illustrated, it should be understood that various embodiments may operate using multiple local area networks 106. In addition, various embodiments may incorporate local area networks 106 in other networks of system 100.

These networks interconnect other elements of system 100, including mobile devices 108, personal computers (PCs) 114, financial services server 118, database 120, and customer information system 122. It should be understood that while system 100 is illustrated as including specific types of networks, various embodiments may operate using any suitable arrangement and collection of networks that enable appropriate communications.

Mobile devices 110 represent portable hardware and appropriate controlling, logic for communicating with other components of system 100. For example, mobile devices 110 may support voice and data communications and be capable of transmitting and receiving multiple forms of media including but not limited to still audio, text messages, video, images, and content from disparate services. In particular embodiments, one or more of mobile devices 110 may include smart phones, personal digital assistants (PDAs), wireless handsets, notebook computer systems, and tablet computer systems according to particular embodiments, mobile devices 110 include wireless devices with advanced user interfaces, such as the APPLE iPhone, iPod Touch, or iPad.

Personal computers (PCs) 114 represent general-purpose computers, including appropriate hardware, controlling logic, and data that may be used to interface with other system components such as financial services server 118, database 120, customer information system 122, and mobile devices 110. For example, PCs 114 may be workstations, laptops, netbooks, tablet computers, personal data assistants (PDAs), or any other suitable computing device. PCs 114 may support a wide variety of operations such as web browsing, word processing, and managing business data. According to particular embodiments, PCs 114 provide access, potentially through web-based interfaces, to information managed by other elements.

Financial services system 118 represents any appropriate combination of hardware, controlling logic, and data for providing and managing financial services information and supporting interactive access to that data from multiple remote (and potentially highly mobile) devices. For example, financial services system 118 may include a networked server or collection of networked servers, or could include in one or more virtual servers capable of acquiring computing resources on-demand depending on the dynamically determined needs of the system. Using virtual servers, financial services system 118 could be scaled dynamically based on system requirements and real-time usage, without limiting operation to a particular physical computer server having fixed computing resources. This could facilitate the scalability, efficient operation, high availability, and cost effectiveness of the system. As illustrated, financial services system 118 couples to networks, such as communications network 102, to facilitate communication to other elements of system 100. Financial services system 118 represents suitable hardware components, controlling logic, and data for managing financial information and/or customer information, such as customer demographic information, customer financial priorities, and/or other relevant information. For instance, financial services system 118 may be embodied in a computer system or a network of computers, which are capable of maintaining customer information such as customer identifiers, account identifiers, retirement packages, plans or programs, and other customer-specific information as appropriate for various aspects for financial account maintenance. Some embodiments of the present disclosure may include a financial services system 118 deployed at a financial services facility, while other embodiments may include a global financial services system 118 for maintaining customer information. As illustrated, financial services system 118 may be coupled to a network, such as local area network 106, to facilitate communication to other elements of system 100. While only one financial services system 118 is shown, it should be understood that various embodiments may include multiple appropriately deployed financial services system 118.

Particular embodiments are designed to operate in a network environment that facilitates the retrieval arid presentation of financial services information to end users of mobile devices 108, facilitating the provision of financial services to customers. In operation, elements of system 100 cooperate generate and/or display customized financial information that is provided to the customer in real time during a retirement or other financial planning session. The information displayed may be selected in response to customer input. In certain embodiments, the elements may operate to determine customer priorities with regard to elements of a retirement planning framework and select or modify the displayed content in response to such priorities, to certain embodiments, the components may be configured to display content that is interactive and responsive to the user input. For example, the content may be modified to reflect the effects of the customer adjusting one or more parameters such as a retirement age or expected inflation rate.

While system 100 is illustrated as including specific components arranged in a particular configuration, it should be understood that various embodiments may operate using any suitable arrangement and collection of components capable of providing functionality such as that described.

FIG. 2 is a block diagram illustrating a system 200 representing an example embodiment of financial services system which has elements that interoperate to provide retirement and/or other financial information. The elements of system 200 can support a number of different operations including maintaining a central unified repository of financial plan information. The elements of system 200 may facilitate the provision of a holistic approach to retirement planning. In certain embodiments, system 200 may provide for the graphical display of a user interface for disseminating retirement information and for receiving customer information from one or more devices such as mobile devices 118 and PCs 114. For example, system 200 may be used to display topic information pages relating to one or more elements of a retirement planning framework. System 200 may be used to receive customer information for determining customer priorities, displaying customized information based on customer identified priorities, and/or presenting interactive content that may be modified based on user input,

System 200 represents any appropriate combination of hardware, controlling logic, and data. For example, system 200 may be one or more computer servers or virtual computer servers capable of providing the appropriate functionality for centrally managing financial plan and customer information. As illustrated, system 200 includes a web server 202, a database 204, a standards-based application programming interface (API) 206, business logic 208, and one or more processors 210.

Web server 202 represents any appropriate combination of hardware, controlling logic and data for interfacing with remote devices using web-based protocols to provide web-based access to the financial information and functionality provided by system 200. For example, web server 202 may be a web host that serves web pages or a mobile application to facilitate access to some or all functions of system 200.

Database 204 represents any appropriate combination of hardware, controlling logic, and data for financial planning information, retirement planning information; retirement planning framework element information, information pages relating to framework elements, customer information, and other system-related data. As illustrated, database 204 has various data components including customer information and retirement and financial planning data. Customer information may include customer demographic information, financial histories, customer retirement preferences and priorities, and/or other relevant financial information. For instance, customer information database 120 may be include customer identifiers (such as a name), general demographic information (such as customer's date-of-birth), customer account identifiers, purchased financial packages, purchased financial services, customer preferences, and other customer-specific information as appropriate for recommending or providing retirement information or services.

Retirement and financial planning data represents a collection of information corresponding to plan offerings provided by the financial planning service. For example, such information may include one or more topic information pages relating to each element of a retirement planning framework. In one particular embodiment, the data may include topic information related to health, family, leisure, finances, giving, home, and/or work. As another example, the data may include infographic that include statistics associated with these or other information topics. Additionally or alternatively, the data may include fact sheets, whitepapers or other informational documents. According to particular embodiments, system 200 may provide retirement and financial planning data to a mobile device 108 based on information maintained in customer data or input received from a user of to mobile device 108.

Provider data represents a collection of information corresponding to various financial providers who interact with system 200, including users of PCs 114 and mobile devices 108. For example, provider data may represent information specific to a financial services agent that provides retirement or other financial services to a customer. Such provider data may include authentication data such as authorized users corresponding to a defined practice location, each authorized user's passwords, each authorized user's system access history, each authorized user's usage preferences, and other access codes. This information can be used to provide secure access to system 200 and as appropriate, prohibit unauthorized access to customer information maintained by system 200.

Standards-based API 206 represents hardware, appropriate controlling logic, and data for interfacing with remote components using standardized processes and protocols. For example, standards-based API 206 may facilitate interactions with mobile devices 108 to support messaging functions, such as through emailing or texting messaging. For example, standards-based API 206 may operate to email certain information displayed to a customer via mobile device 108 or requested by a customer via mobile device 108 to the customer. For example, standards-based API 206 may operate to email topic information pages, whitepapers, and/or fact sheets that are displayed to a customer via mobile device 108 to the customer directly for their future use.

Business logic 208 represents hardware, controlling logic and data associated that controls the fundamental operation and administration of system 200, including interactions of elements to provide the interactive topic information described herein. For example, business logic 208 may be software for execution by one or more processors to provide a central financial planning or retirement planning service that interfaces with mobile devices 108. Processor 210 represents one or more computer processors for executing business logic 208 or other software or controlling logic associated with elements of system 200.

In operation, elements of system 200 operate together to perform various functions of the present disclosure, including maintaining a central, unified repository of financial and retirement planning information and, in some embodiments, facilitating the maintenance of customer information including customer preferences, customer priorities, and customized financial/retirement offerings. System 200 uses this information to support applications on mobile devices 108 that can interface with and graphically present that information to customers. For example, the applications on mobile devices 108 may be used to identify customer preferences and priorities, provide customized information based on the identified customer preferences and priorities, and modify the displayed information in response to user input.

For example, elements of system 200 are operable to maintain a central, unified repository of retirement and financial planning data and/or customer data. In particular, processors 212 may execute appropriate business logic 210 to communicate with one or more mobile devices 108 and/or provide an application on mobile devices 108 for use in providing retirement and financial planning services to a customer. System 200 stores information in database 204, generates or retrieves topic information (for example, based on customer input received from a mobile device 108), and communicates information from database 204 to computing devices (e.g. mobile devices 108 and PCs 114). This information can then be used by a graphical user interface to display and facilitate real-time data entry and management of a customer account.

During operation, system 200 provides financial planning information, such as retirement planning information, for presentation and use by graphical user interfaces presented on mobile devices 108. For example, system 200 may provide an application that presents various elements of a retirement planning framework to a user of mobile device 108. In one particular embodiment, the elements may be included on a topic dashboard or other graphical user interface screen. For example, the elements may include health, family, leisure, finances, giving, home, work, or any combination of these or other appropriate topics.

In one particular embodiment, the information may be displayed in a system-defined order. Thus, the order and content of the information displayed may be defined by system 200. For example, one or more infographics, question and answer pages, cost calculators, fact sheets, or any combination of these or other screens may be displayed to the user. In other embodiments, the customer may selectively navigate between topics to learn more about each topic within the framework. For example, from the topic dashboard, the customer may select “health” as a topic that the user wishes to learn more about. System 200 may then provide various graphical user interface screens that relate to the topic of health. System 200 may require the customer to step through each screen. Alternatively, system 200 may allow the customer to return to the topic dashboard at any time. Upon returning to the topic dashboard, the customer may then select a different topic from the topic dashboard. System 200 may then provide information related to the selected topic.

In certain embodiments, system 200 may also be used to provide customized information relating to the information topics displayed on mobile devices 108. In a particular embodiment, a customer may use mobile device 108 to identify customer priorities and preferences. Specifically, for example, a user of mobile device 108 may be able to select elements of a higher priority or identify a priority ranking of each element with respect to the other elements. In a particular embodiment, the order in which information is displayed may be selected based on the customer-identified priorities and preferences. For example, system 200 may operate to select information to be displayed to the user in an order of the customer's highest priority to the customer's lowest priority. Thus, if a customer using mobile device 108 identifies health as being a higher priority than travel, system 200 may display topic information relating to health before displaying topic information relating to travel.

System 200 may also operate to modify the information displayed to the customer in response to receiving customer input. In a particular embodiment, the content of a standard topic information page may be modified based on the priorities identified by the customer. Additionally or alternatively, the content of a standard topic information page may be modified after it is displayed to the customer in response to receiving input from the customer. Thus, a standard topic information page may be displayed in response to a customer selecting a topic from a topic dashboard. The standard topic information page may include interactive content such as one or more adjustable parameters that may, when selected by the customer, cause the information that is displayed to be adjusted. As one example, a standard topic information page may include a questionnaire. System 200 may generate or select topic information pages for display to the customer in response to receiving the customer's answers to the questionnaire. As another example, the adjustable parameters may be used to identify a customer concern level associated with an element. As another example, the adjustable parameter may allow a customer to identify the customer's age and the information that is displayed may be adjusted in response to the customer's age. Specifically, cost data associated with health care could be adjusted in response to the age identified by the customer. As another example, the adjustable parameter may relate to an inflation rate and the information that is displayed may be adjusted in response to an adjustment of the inflation rate.

While system 200 is illustrated as including specific components, it should be understood that various embodiments may operate using any suitable arrangement and collection of components.

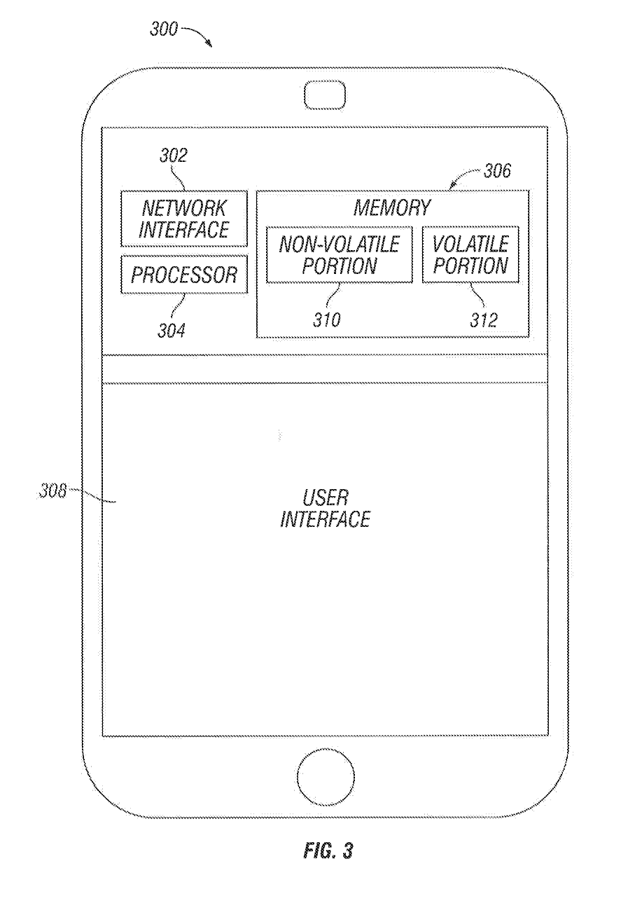

FIG. 3 is a block diagram illustrating a mobile device 300 representing an example embodiment of mobile device 108. As illustrated, mobile device 300 includes a number of components that operate together to selectively display financial and retirement planning information to a customer of a financial services provider. Mobile device 300 can support a number of different operations, including displaying information pages that may be customized to provide a holistic approach to financial and retirement planning. In addition, mobile device 300 may facilitate the gathering of customer information that may be used to customize the information displayed to the customer. Mobile device 300 may be further operable to display financial and retirement plans that have been selected or generated to meet specific customer needs.

As illustrated, mobile device 300 includes a number of components for maintaining and displaying medical information. Mobile device 300 may represent any suitable portable hardware, including appropriate controlling logic and data capable of communicating with remote devices and systems, receiving user input, and displaying medical information. As shown, mobile device 300 includes several components, which may include a network interface 302, a processor 304, a memory 306 and a user interface 308. The illustrated embodiment further discloses memory 306 as including a non-volatile portion of memory 310 and a volatile portion of memory 312.

Network interface 302 represents any appropriate combination of hardware and controlling logic for coupling to one or more networks. Network interface 302 may support any number of suitable protocols for communicating on a communication network. For example, network interface 302 may be a wireless local area network interface, cellular network interface, satellite interface, and/or any other appropriate interface for communicating on a communication network. Network interface 302 may have multiple interfaces for handling different communication protocols.

Processor 304 represents one or more processing elements, including hardware, logic, and data capable of controlling the operation of mobile device 300. For example, processor 304 may be a computer processor for executing a medical information management application stored in memory 306, or any other software or controlling logic associated with mobile device 300, such as a mobile operating system.

Memory 306 represents appropriate hardware and control logic for maintaining a medical information management application and case information corresponding to one or more medical practices. Memory 306 may also include storage for other data, such as a mobile operating system of mobile device 300. As illustrated, memory 306 includes a non-volatile portion 310 and a volatile portion 312. Non-volatile portion 310 of memory 306 represents memory for maintaining persistent applications and/or data. Volatile portion 312 of memory 306 represents storage for maintaining non-persistent applications and/or data. According to particular design considerations, the financial planning application and the data associated therewith may be stored in the non-volatile portion 310 of memory 306, while preferences, priorities, and other customer information may be stored in the volatile portion 312 of memory 306. Such an implementation provides added security to critical data and helps to ensure that confidential customer information is not readily accessible even if mobile device 300 is lost or otherwise compromised.

Mobile device 300 also includes a user interface 308. User interface 308 represents any appropriate combination of hardware, control logic, and data for displaying information to a user and receiving inputs from a user. Thus, user interface 308 includes any input and/or output interface. For example, a user interface may be a touch screen interface that is capable of both displaying graphical information and receiving user inputs. User interface 308 of mobile device 300 may be used to display financial planning information using a financial planning application and receive customer input, which may be forwarded to financial services system 118 in some embodiments.

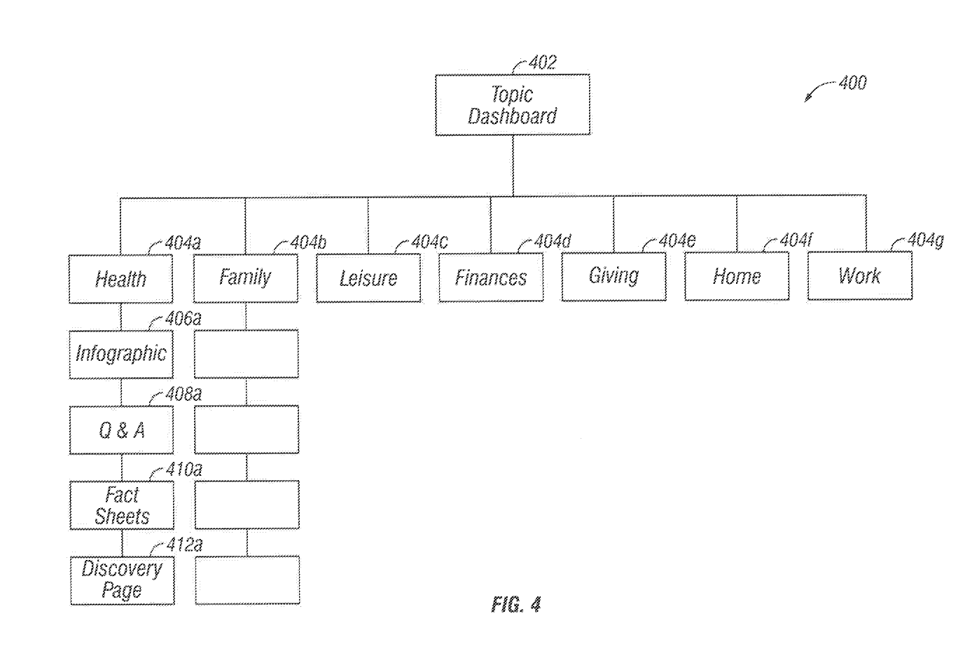

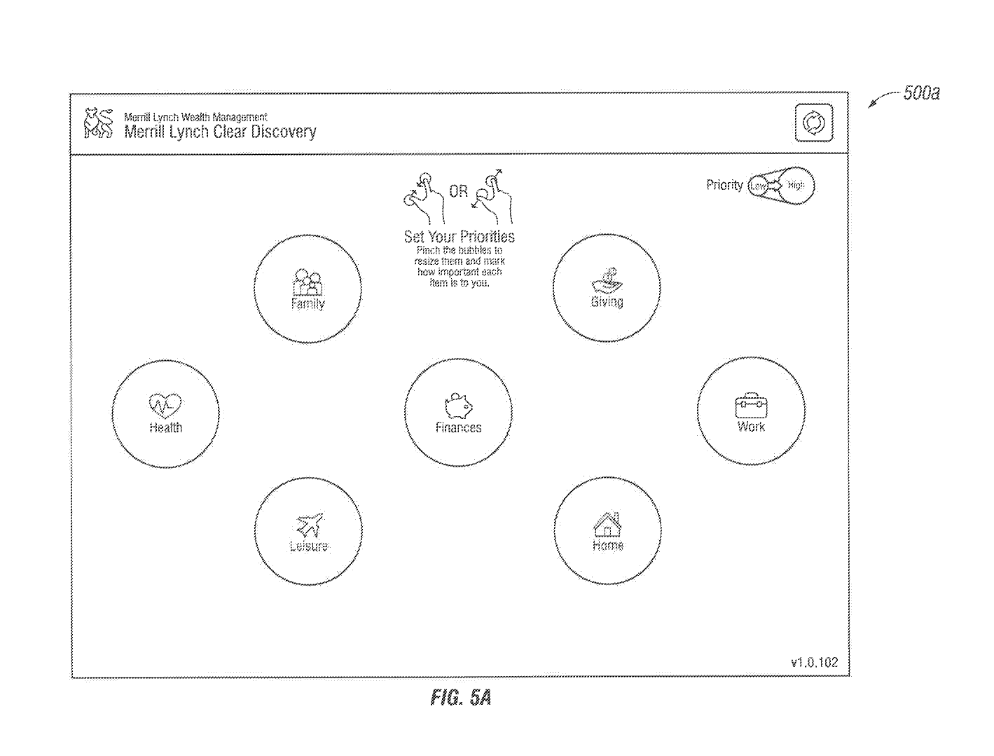

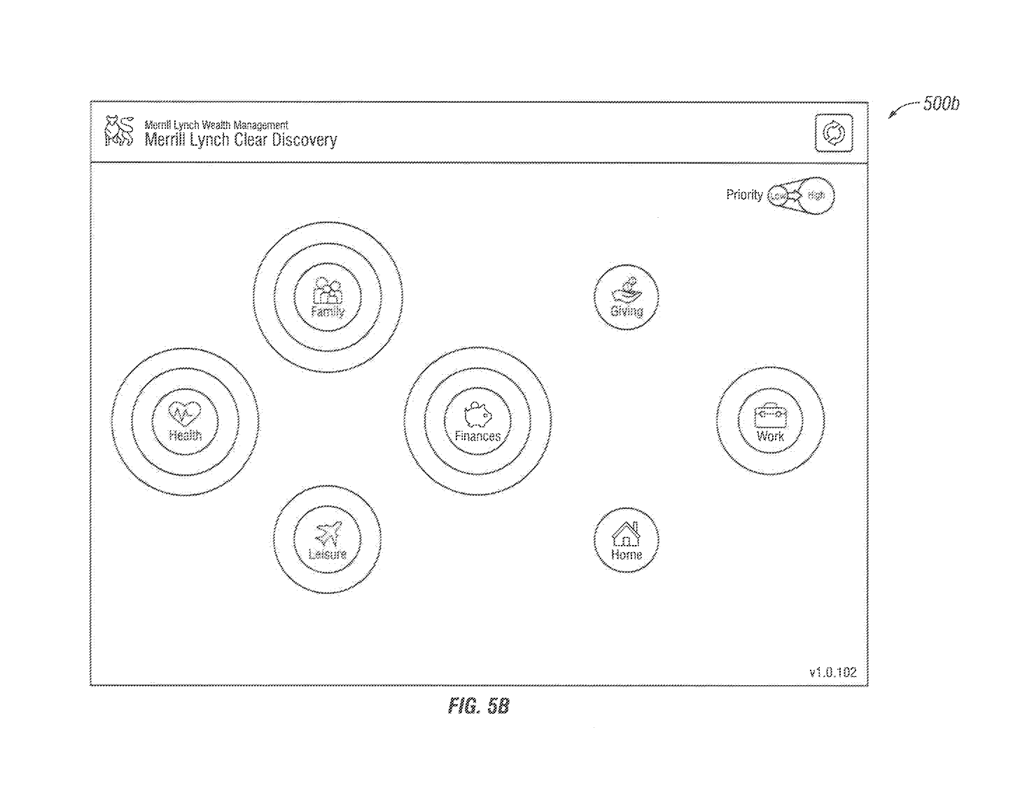

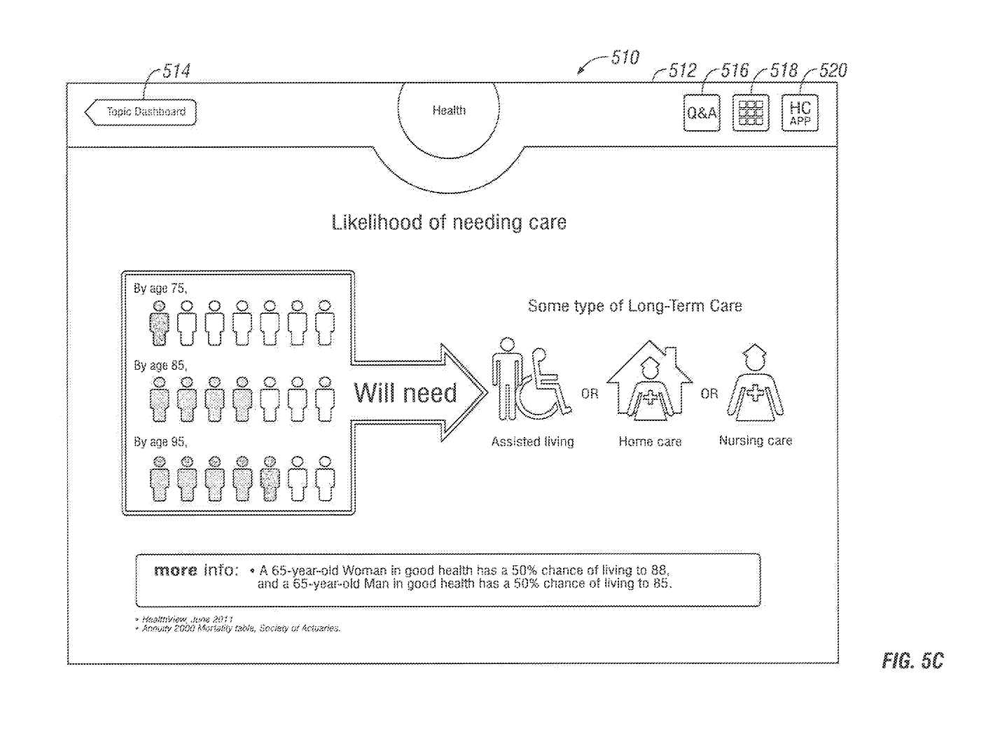

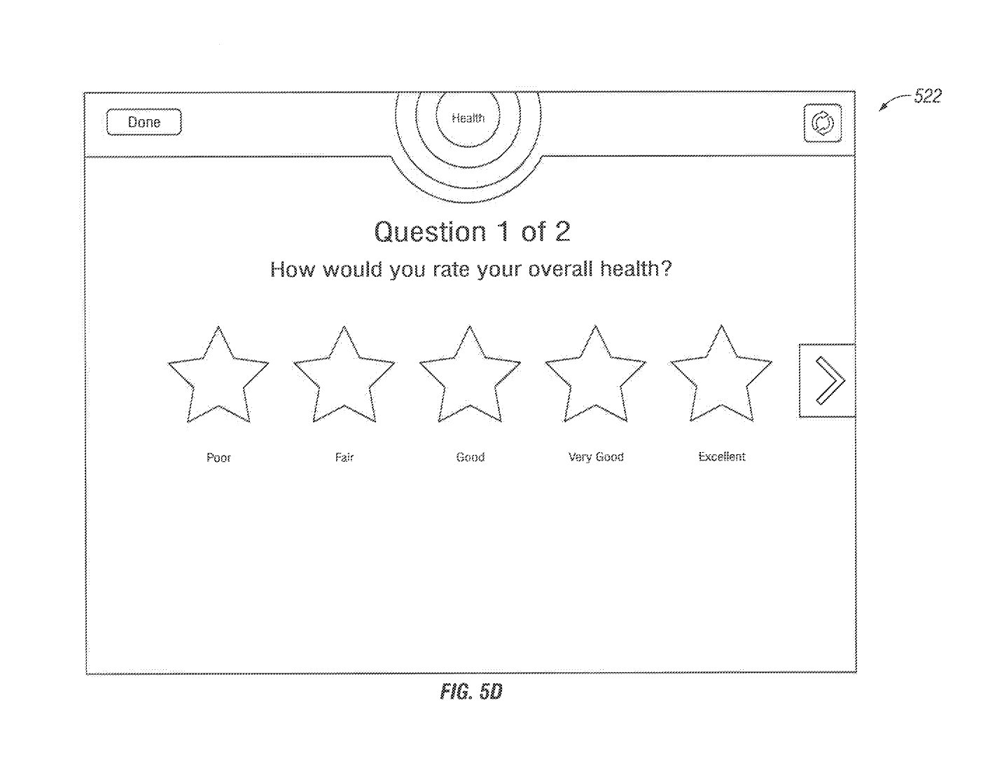

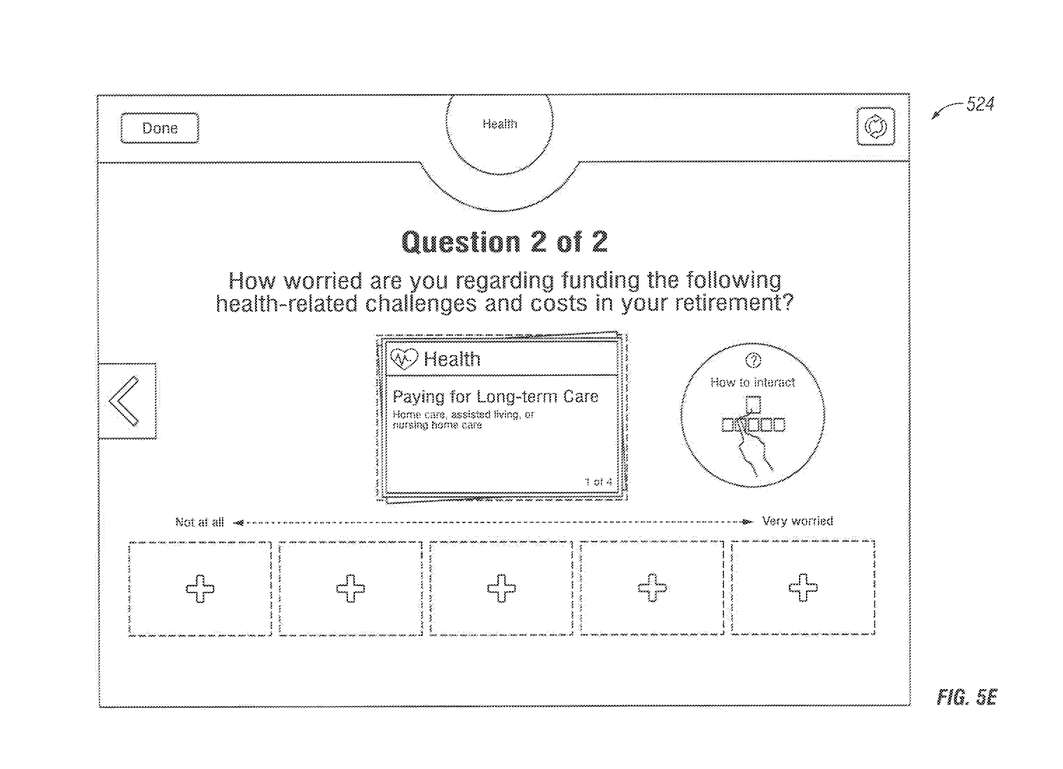

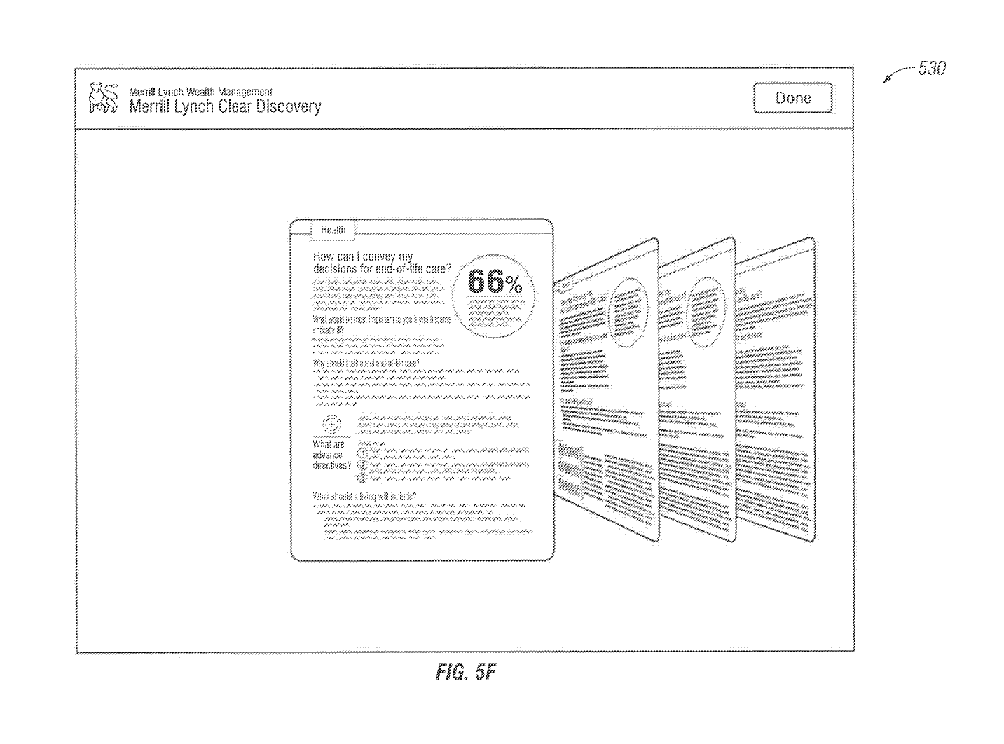

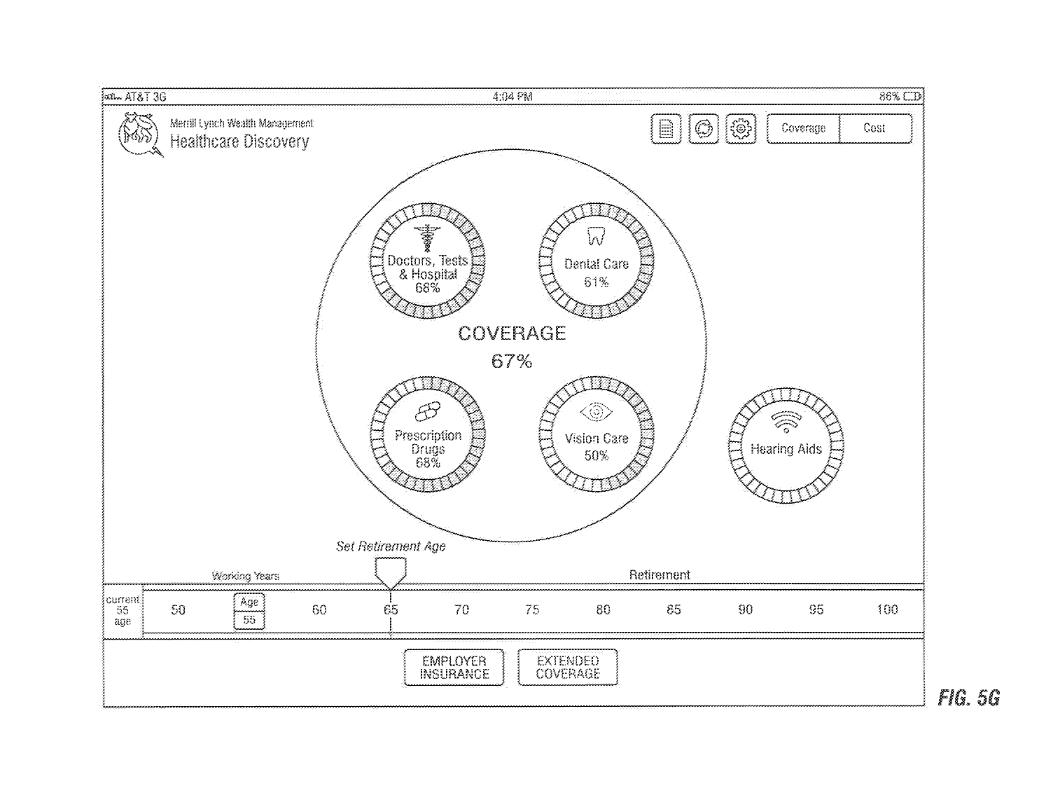

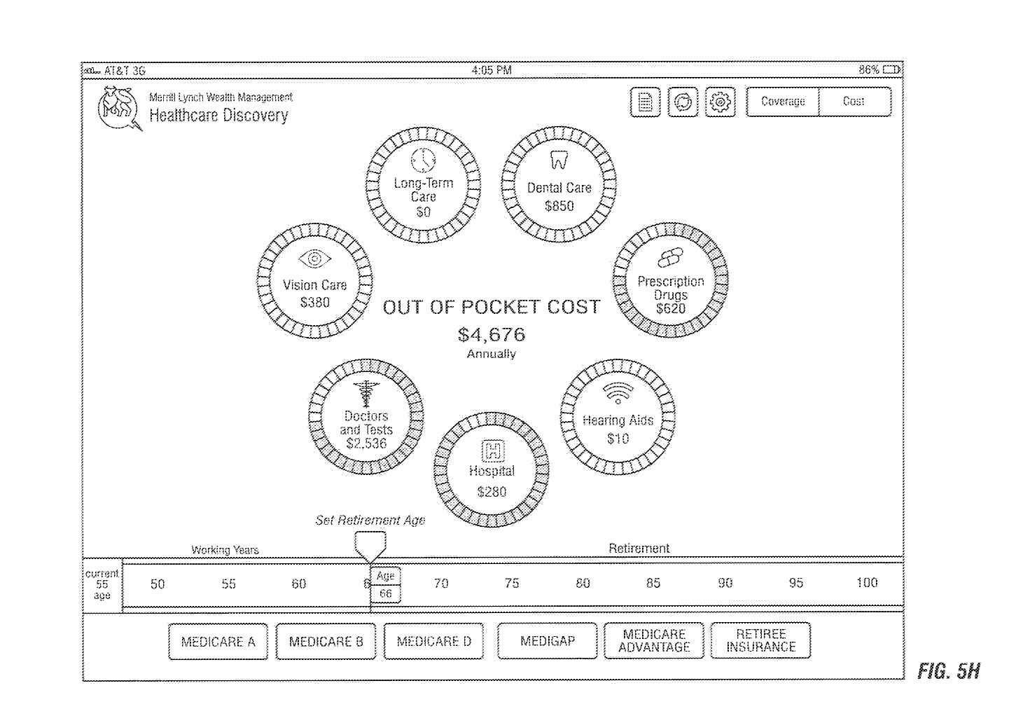

In operation, elements of mobile device 300 perform various functions including facilitating maintenance and display of a topic dashboard, enabling selection and display of individual topic information pages pertaining to the topics on the topic dashboard, providing an intuitive graphical user interface for interacting with the user of mobile device 300, and displaying customized information based on user input. Specifically, processor 304 may execute a financial planning application residing in a nonvolatile portion 310 of memory 306 for the display of financial planning information to a customer using mobile device 300. As will be described in more detail below with regard to FIG. 4 and FIGS. 5A-H, mobile device 300 may use user interface 308 to display a graphical topic dashboard that includes buttons associated with the elements of a retirement planning framework. Where a button is selected through the user interface 308, one or more additional topic information pages may be selected and displayed to the customer using mobile device 300.

While mobile device 300 is illustrated as including specific components, it should be understood that various embodiments may operate using any suitable arrangement and collection of components.

FIG. 4 is a system hierarchy 400 for a graphical user interface on a handheld device. As illustrated, system hierarchy 400 includes a number of display screens including a topic dashboard 402, and topic information pages 404a-g for displaying information to a customer using mobile device 108.

Topic dashboard 402 may operate as a landing page that may be used as an introduction to the information to be conveyed to the customer via the graphical user interface screens. An example topic dashboard 500 is depicted in FIG. 5A. In the illustrated embodiment, a number of selectable buttons 502a-g are displayed. Each button 502a-g corresponds with an element of a retirement planning program. Specifically, buttons 502a-g relate to one of health, family, leisure, finances, giving, home, and work. However, it is recognized that the financial planning framework may include fewer, more, or different elements than those depicted.

In FIG. 5A, tone dashboard 500a also includes a set of instructions 504 that explain to a user that a priority ranking can be assigned to the framework elements. Specifically, mobile device 108 includes a touch screen that can be touched using a pinching motion to resize each button 502a-g to mark how important each item is to the customer. Thus, if health is of paramount importance, button 502a may be made bigger than all other buttons 502b-g. Conversely, if leisure is the least important, button 502e may be made smaller than all other button 502a-d and 502f-g. In this manner, each button 502a-g can be sized as the customer deems appropriate to indicate the priority of each element of the framework to the customer.

FIG. 5B depicts topic dashboard 500h after the customer has adjusted the sizes of buttons 502a-g to indicate the customer's priorities and preferences. In this particular example, the customer has identified the framework elements of 502a, 502b, and 502c of being of equally high importance. Thus, the customer's priorities in developing a financial plan may lie in health, family, and finances. Conversely, the customer has identified the framework elements of 502d and 502f as being of least importance, indicating that the customer does not indicate giving or home to be of high priority. The customer has further indicated that the framework elements of 502e and 502g to be of middle importance. Thus, the customer considers leisure and work to be of lower priority than health, family, and finances, but of higher priority than giving and home.

In a particular embodiment, the customer may select a particular one of the buttons 502a-g to receive additional information related to that particular framework element. For example, if the user selects the health button 502a, a number of topic information pages relating to the health framework element 404a may be available for viewing. As depicted, such information pages may include one or more infographic screens 406a, questionnaire screens 408a, fact sheets and or white papers 410a, discovery pages a412, and/or interactive information screens 414a.

FIG. 5C depicts an example heath infographic 510. The infographic may depict any relevant information associated with the particular framework element selected. However, in the illustrated example, infographic 510 seeks to educate the customer on the likelihood of needing health care throughout the retirement years. Specifically, infographic 510 visually depicts that the likelihood of needing some type of long-term care increases as one ages from 75 to 95. Infographic 510 also depicts, as examples, some types of health care that may be required. Infographic 510 may be used to convey any desired information to the customer. In the illustrated example, the infographic 510 includes additional information relating to life expectancy.

In a particular embodiment, infographic 510 (or any other of the screens associated with graphical user interface hierarchy 400) may also include a menu strip 512 across the top of the screen that includes a number of buttons that a user of mobile device 108 may use to drive the financial planning session. For example, a topic dashboard button 514 may be selected for returning to the topic dashboard screen 500a-b. Additionally, infographic 510 may include a Q&A button 516, an additional information button 518, and/or a health care (HC) app button 520. Selecting anyone of these buttons may cause additional screens to be displayed to the customer. For example, Q&A button 516 may take the user to one or more Q&A screens 408a. FIGS. 5D-5E depict example Q&A screens 522 and 524, respectively, Q&A screen 522 solicits the customer to rate their overall health. The customer using mobile device 108 may select an appropriate star to identify the customer's quality of health. Q&A screen 524 includes an interactive screen that allows the user to input on a sliding scale how worried the customer is about finding a set of health-related challenges that may be dragged and dropped to indicate the customer's level of concern and preferences.

As another example, information button 518 may allow the user to view one or more fact sheet screens 410a. The HC app button 520 may cause one or more discovery pages 412a and/or interactive information pages 414a to be displayed. In other embodiments, all or a portion of menu strip 512 may be omitted, and the order of the screens within graphical user interface hierarchy 400 may be predefined. In such an embodiment, the customer using mobile device 108 could merely swipe a finger across the touch screen of mobile device 108 to cause the next screen to be displayed.

Though each framework element 404a-404g is depicted as including the same available screens (i.e., infographics, questionnaires, fact sheets, discover pages, and interactive information screens), it is generally recognized, that the framework elements 404a-g may have less, more, and/or different information pages available for viewing. In particular embodiments, if the user selects the family button 502b on landing page 500, the information pages displayed may include infographics explaining the likelihood and challenges of becoming a caregiver to other family members. Information pages relating to the family element 404b may include questionnaires crafted to determine the likelihood that the others will require financial support from the customer, and/or other information related to familial expenses and obligations that may be incurred during retirement. As further examples, information pages relating to leisure 404c may provide information relating to allocating retirement funds for travel, hobbies, spending time with loved ones, improving health and fitness, volunteering, resting and relaxing, continuing education, or other suitable information. The information pages relating to finances 404d may provide information relating to the accumulation of wealth, social security benefits, or other income related topics.

As still further examples, the information pages related to giving 404e may describe the benefits of volunteering, provide information about volunteer opportunities and/or solicit information from the customer to determine the types opportunities are best suited for the customer. Additionally, questionnaires or other information pages may be provided to determine the customer's goals relating to the customer's goals and preferences as to the disposition of assets upon death. Information pages related to home 404f may describe the various living arrangements that are available to senior citizens and solicit information from the customer so as to determine whether a change in living arrangements may be desired. Information pages related to work 404g may provide information as to the benefits and costs of working during retirement.

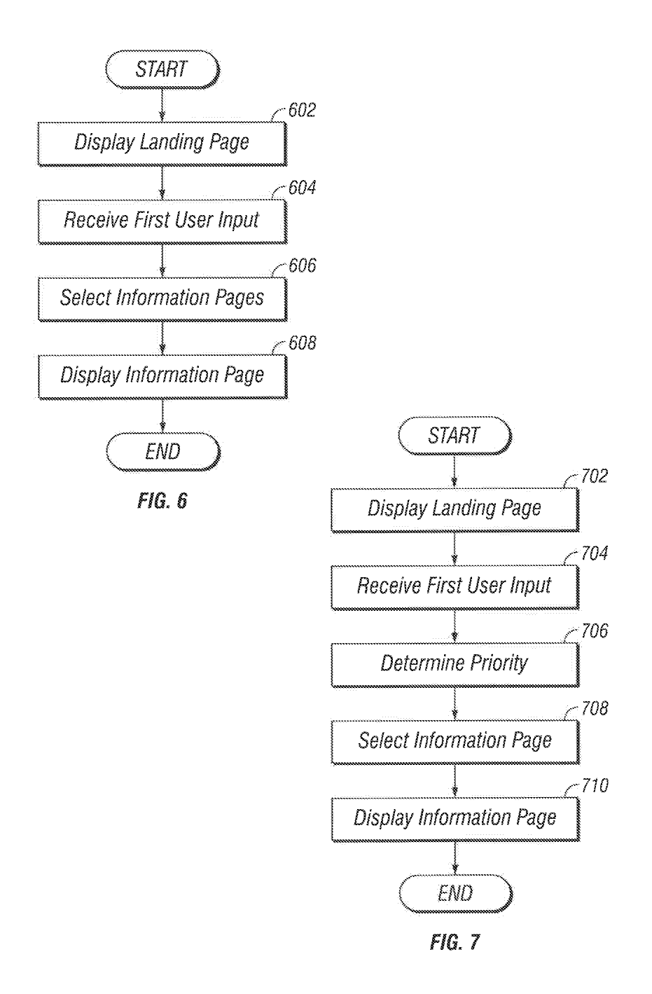

FIG. 6 is a process flow diagram illustrating an example method 600 customized information to a customer for financial planning such as, for example, retirement. The method begins at step 602 with the display of a landing page. The landing page includes multiple topic identifiers that are each associated with an element within a framework for retirement planning. In certain embodiments, the topic identifiers may include topics such as health, family, leisure, finances, giving, home, work, or any combination of these or other retirement or financial planning topics.

In certain embodiments, the landing page may be displayed on a mobile device 108 that includes a touch screen. In such an embodiment, the topic identifiers may be individually selected by the customer or another user touching a topic identifier on the display. For example, each topic identifier may be represented as a labeled bubble that can be touched for selection. Accordingly, the method may continue at step 604 when a first user input is received. The first user input may identify a topic identifier about which the user desires additional information. For example, the first user input may identify that the user desires additional information about “finances” or “health” or any one of the previously displayed topics.

In response to the first user input, a set of information pages may be selected for display to the customer at step 606. The set of information pages may relate specifically to the topic selected by the user. At step 608, one of the information pages may be displayed to the user. In a particular embodiment, the information page may include one or more purchasable health insurance offerings. In another embodiment, the information page may include one or more retirement plans that the customer may select to enroll in. Additionally or alternatively, the information page may include an infographic depicting statistics relating to the selected topic or the information page may include a questionnaire related to the topic. As still another example, the first information page may include a fact sheet, white paper, or, other informational material that may be relevant to the selected frame work element.

In certain embodiments, the display order of the set of information pages may be pre-defined. Thus, each page within the set of information pages may be displayed to the user in a pre-defined order. For example, if the application includes five information pages relating to health, the application may display the five information pages in a pre-defined order for every customer that uses the application. Alternatively, the display order of the set of information pages may be customer-selected. For example, a first information page may include a listing of the set of information pages relating to the selected topic of “health,” Links may be provided to allow the customer to select only on those information pages that the customer wishes to view.

In certain embodiments, the content of an information page that is displayed at step 608 may be modified in response to user input. For example, an infographic may be displayed that includes parameters that may be adjusted by the user to result in a variation of the statistics displayed. Thus, if the infographic depicts expected costs of health insurance during retirement, a parameter relating to the expected age of retirement might result in the cost being raised or lowered in response to user input. As another example, the user might adjust a parameter relating to the customer's quality of health that may also result in the cost being raised or lowered.

In certain embodiments, an information page that is displayed may solicit user input that affects the content of subsequently displayed information pages. For example, if a questionnaire is displayed, the questionnaire may solicit information from the customer that may result in modifications to the content of first information page.

FIG. 7 is a process flow diagram illustrating an example method 700 customized information to a customer for financial planning such as, for example, retirement. The method begins at step 702 with the display of a landing page. The landing page includes multiple topic identifiers that are each associated with an element within a framework for retirement planning. In certain embodiments, the landing page may be displayed on a mobile device 108 that includes a touch screen. In such an embodiment, the topic identifiers may be individually selected by the customer or another user touching a topic identifier on the display. For example, each topic identifier may be represented as a labeled bubble that can be touched for selection.

The method may continue at step 704 when a first user input is received. In response to the first user input, a priority of at least one element within the framework for retirement planning may be determined. The priority of the element may be determined relative to the other elements within the framework. For example, assume that the elements of the framework for retirement planning include topics such as health, family, leisure, finances, giving, home, and/or work. In a particular embodiment, each element may be displayed as a bubble that may be manipulated such that it can be resized to demonstrate whether the customer prioritizes that element over other elements within the framework. In such an embodiment, the user might be able to pinch the “finances” bubble on the screen to make the “finances” bubble larger to indicate that the customer considers the finances element to be of higher priority than other elements within the framework. As another example, the user might be able to make the “leisure” bubble smaller to indicate that the customer considers the “leisure” element to be of lower priority than the other elements within the framework. In this manner, the customer may resize each bubble to identify the customer's overall goals, preferences, and priorities. Accordingly, in certain embodiments, the first user input may include an indication of such preferences and priorities from the customer. The priority of each element with respect to every other element within the framework may be determined based on the first user input at step 706.

At step 708, a first information page may be selected for display to the customer. The first information page may relate to one or more of the elements selected at step 704 and determined to be a priority at step 706. Thus, the first information page may be selected based at least in part on the priority of the element associated with the first information page. For example, where the first user input identifies the “finances” element as being of highest priority to the customer, an information page relating to “finances” may be selected and displayed to the customer at step 710. Additional information pages may be subsequently displayed to the customer in an order that is determined based on the priorities assigned to each element. Thus, if the customer identified “health” as being the customer's second highest priority, one or more “health” information pages may be displayed after the “finances” information pages are displayed.

In certain embodiments, the content of the first information page that is displayed at step 708 may be modified based on the priority assigned to the element associated with the first information page. In certain embodiments the first information page may include info graphic information that depicts statistics relating to the particular element of the framework for retirement planning. In other embodiments, the first information page may include a questionnaire related to the framework element. The questionnaire may solicit information from the customer that may result in modifications to the content of first information page, in still other embodiments, the first information page may include a fact sheet, white paper, or other informational material that may be relevant to the selected framework element.

Although the present disclosure describes several embodiments, it should be understood that a myriad of changes, substitutions, and alterations can be made without departing from the spirit and scope of the invention as defined by the appended claims.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDS), magneto-optical discs, magneto-optical drives, floppy diskettes, floppy disk drives (FDDs), magnetic tapes, solid-state drives (SSDs). RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A method comprising:
on a mobile computing device, displaying a landing page comprising a topic dashboard, the topic dashboard depicting a plurality of topic identifiers selected from a group consisting of health, family, leisure, finances, giving, home, and work, each of the plurality of topic identifiers comprising an element of a retirement plan;
by the mobile computing device, receiving a first user input identifying a selected particular topic identifier within the plurality of topic identifiers;
by the mobile computing device and in response to the first user input, selecting a plurality of topic information pages relating to the particular topic identifier, the plurality of topic information pages comprising information relating to the particular topic identifier selected from the group consisting of health, family, leisure, finances, giving, home, and work; and
by the mobile computing device, displaying at least one of the plurality of topic information pages to the user.

2. (canceled)

3. The method of claim 1, wherein displaying the at least one of the plurality of topic information pages comprises:
displaying the plurality of topic information pages relating to the particular topic identifier in a pre-defined order.

4. The method of claim 1, wherein displaying the at least one of the plurality of topic information pages comprises:
displaying the plurality of topic information pages relating to the particular topic identifier in a user-selected order.

5. The method of claim 1, wherein displaying the at least one of the plurality of topic information pages to the user comprises:
displaying a plurality of links, each of the plurality of links selectable by the user to direct the user to a particular one of the plurality of topic information pages relating to the particular topic identifier.

6. The method of claim 1, wherein:
the particular topic identifier is health; and
displaying the at least one of the plurality of topic information pages comprises displaying one or more purchasable health insurance offerings.

7. The method of claim 1, wherein:
the particular topic identifier is finances; and
displaying the at least one of the plurality of topic information pages comprises displaying one or more retirement plans offered to the user.

8. The method of claim 1, wherein displaying the first topic information page comprises displaying an infographic depicting statistics relating to the element of the retirement plan.

9. The method of claim 1, wherein displaying the first topic information page comprises displaying a questionnaire related to the element of the retirement plan, the questionnaire soliciting user input from the user.

10. The method of claim 9, further comprising:
modifying a second topic information page related to the element of the retirement plan based on user input received from the user in response to the questionnaire; and
displaying the second topic information page to the user.

11. One or more computer-readable non-transitory storage media embodying logic that is operable when executed by one or more processing units to:
display a landing page comprising a topic dashboard, the topic dashboard depicting a plurality of topic identifiers selected from a group consisting of health, family, leisure, finances, giving, home, and work, each of the plurality of topic identifiers comprising an element of a retirement plan;
receive a first user input identifying a particular topic identifier within the plurality of topic identifiers;
in response to the first user input, select a plurality of topic information pages relating to the particular topic identifier, the plurality of topic information pages comprising information relating to the particular topic identifier selected from the group consisting of health, family, leisure, finances, giving home, and work; and
display at least one of the plurality of topic information pages to the user.

12. (canceled)

13. The computer-readable non-transitory storage media of claim 11, wherein when displaying the at least one of the plurality of topic information pages the logic is further operable to:
display the plurality of topic information pages relating to the particular topic identifier in a pre-defined order.

14. The computer-readable non-transitory storage media of claim 11, wherein when displaying the at least one of the plurality of topic information pages the logic is further operable to:
display the plurality of topic information pages relating to the particular topic identifier in a user-selected order.

15. The computer-readable non-transitory storage media of claim 11, wherein when displaying the at least one of the plurality of topic information pages to the user the logic is further operable to:
display a plurality of links, each of the plurality of links selectable by the user to direct the user to a particular one of the plurality of topic information pages relating to the particular topic identifier.

16. The computer-readable non-transitory storage media of claim 11, wherein the selected topic identifier is health, and when displaying the at least one of the plurality of topic information pages the logic is further operable to display one or more purchasable health insurance offerings.

17. The computer-readable non-transitory storage media of claim 11, wherein the selected particular topic identifier is finances, and when displaying the at least one of the plurality of topic information pages the logic is further operable to display one or more retirement plans offered to the user.

18. The computer-readable non-transitory storage media of claim 11, wherein when displaying the first topic information page the logic is further operable to display an infographic depicting statistics relating to the element of the retirement plan.

19. The computer-readable non-transitory storage media of claim 11, wherein when displaying the first topic information page the logic is further operable to display a questionnaire related to the element of the retirement plan, the questionnaire soliciting user input from the user.

20. The computer-readable non-transitory storage media of claim 19, wherein the logic is further operable to:
modify a second topic information page related to the element of the retirement plan based on user input received from the user in response to the questionnaire; and
display the second topic information page to the user.
